(19) United States
(12) Patent Application Publication
(10) Pub. No.: US 2025/0291081 A1
(43) Pub. Date: Sep. 18, 2025

(54) DATA-BASED FORMATION ELASTIC PROPERTY EVALUATION WITH TRANSFERABLE MAPPING PARAMETERS

(71) Applicant: Halliburton Energy Services, Inc., Houston, TX (US)

(72) Inventors: Bei Li, Singapore (SG); Michael Stephen Pierce, Houston, TX (US); Yadong Wang, Singapore (SG); Xiang Wu, Singapore (SG)

(21) Appl. No.: 19/016,943

(22) Filed: Jan. 10, 2025

Related U.S. Application Data
(60) Provisional application No. 63/565,391, filed on Mar. 14, 2024.

(51) Int. Cl. G01V 1/30; E21B 44/00

(52) U.S. Cl. CPC G01V 1/306; E21B 44/00; G01V 2210/6242

(57) ABSTRACT

A method comprises obtaining a first drilling dataset corresponding to a first bottom hole assembly drilling a first wellbore. The method comprises determining mapping parameters based on the first drilling dataset and elastic properties of the first wellbore. The method comprises obtaining a second drilling dataset corresponding to a second bottom hole assembly drilling a second wellbore. The method comprises determining the elastic properties of the second wellbore based on the second drilling data and the mapping parameters.

### FIELD

The disclosure generally relates to drilling of wellbores and more particularly, to identifying rock elastic properties while drilling a wellbore.

### BACKGROUND

A drill bit may be utilized to physically cut the rock to form a wellbore in a subsurface formation. Rock elastic properties along the wellbore offer vital insights for geological assessments during the drilling process and the stimulation optimization. These elastic properties, such as Young's modulus, Poisson's ratio, and elastic anisotropic parameters play pivotal roles in determining lithology, porosity, permeability, etc. of the subsurface formation. In drilling optimization, knowledge of rock elastic properties aids the approximation of rock strength, which can guide drill bit material selection and cutting structure design for enhanced efficiency. For well completion and stimulation, Young's Modulus and Poisson's ratio influence casing design and hydraulic fracturing. Generally, rock elastic properties are critical for informed wellbore drilling and reservoir production.

### BRIEF DESCRIPTION OF THE DRAWINGS

Implementations of the disclosure may be better understood by referencing the accompanying drawings.

FIG. 1 is a schematic depicting an example well system, according to some implementations.

FIGS. 2A-2B are schematics depicting an example drill bit, according to some implementations.

FIG. 3 is an illustration depicting a bit-rock interaction model, according to some implementations.

FIG. 4 is a flowchart depicting example operations to calibrate a bit-rock interaction model, according to some implementations.

FIG. 5 is a flowchart depicting example operations to determine one or more rock elastic properties of a subsurface formation utilizing transferrable mapping parameters from a calibration wellbore, according to some implementations.

FIG. 6 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. For instance, this disclosure refers to drill bit vibrations and rate of penetration (ROP) as drilling data. Aspects of this disclosure can also be applied to any other types of drilling data. In other instances, well-known instruction instances, protocols, structures, and techniques have not been shown in detail in order not to obfuscate the description.

Example implementations relate to determining rock elastic properties of a subsurface formation with transferable mapping parameters. The elastic properties may include Young's modulus, Poisson's ratio, etc. Rock elastic properties along a wellbore may offer vital insights for geological assessments during the drilling process and the stimulation optimization. Conventional operations may determine elastic properties via wireline logging and/or logging while drilling (LWD), with sonic logging being indispensable for measuring P-wave and S-wave slowness. Combined with neutron density logging, these tools may assess rock elastic properties, like Young's Modulus and Poisson's ratio. In some implementations, a bit-rock interaction model may utilize drilling data (such as drill bit vibrations, rate of penetration (ROP), etc.) to determine rock elastic properties while drilling. Compared with wireline, LWD sonic logs, etc., a bit-rock interaction model may be a more economic in determining rock elastic properties. However, when different bottom hole assemblies (BHAs) (i.e., drill bits, mud motors, etc.) are used to drill different sections of the wellbore, different wellbores, etc., the bit-rock interaction model may need to be recalibrated for each BHA. In some implementations, transferable mapping parameters may be utilized to employ the bit-rock interaction model across different BHAs, thus avoiding recalibration of the model when applied to different BHAs.

In some implementations, mapping parameters may be utilized to linearly map processed drilling data into stress representatives and strain representatives to further determine rock elastic properties. The mapping parameters may be transferrable from a calibration wellbore to another wellbore where different BHAs may be used. For example, drilling data and rock elastic properties may be obtained from a wellbore drilled with a BHA. Drilling parameters may include drill bit vibrations, rate of penetration (ROP), etc. Rock elastic properties may include Young's modulus, Poisson's ratio, etc. The drilling data and rock elastic properties (obtained from sources such as sonic logs, LWD sonic logs, etc.) may be input into a bit-rock interaction model to calibrate said model, resulting in the generation of mapping parameters. The mapping parameters may then be transferred to another wellbore being drilled by a different BHA (e.g., a drill bit with an effective radius different than the drill bit utilized in the calibration wellbore). By employing the bit-rock interaction model and drilling data from the other wellbore drilled, the transferred mapping parameters may be utilized to determine the rock elastic properties of the subsurface formation near the other wellbore being drilled. For example, the mapping parameters may be utilized in the bit-rock interaction model to estimate the Poisson's ratio directly, via the drilling data. Moreover, the Young's modulus may be scaled by a constant, which can be seen as an effective bit radius ratio between BHAs corresponding to the drilling data for calibration and prediction. In some implementations, such constant scale may be approximated based on an averaged Young's modulus for a depth range of the target wellbore, which can be derived from background geological model, sonic logs from neighboring wells, or LWD sonic logging slightly behind the drill bit.

In some implementations, the transferable mapping parameters may reduce the requirement for deriving rock elastic properties from the drilling data as it may utilize the transferred mapping parameters from other wellbores drilled by different BHAs. This may allow for rock elastic properties to be determined for historically collected drilling data without corresponding sonic logs or cement drilling records. The transferable mapping parameters may provide more accurate and consistent estimation of rock elastic properties. Since the transferred mapping parameters may be calibrated from datasets with the highest quality (high sampling rate, well matching between reference sonic logs and drilling data, etc.), whereas traditional mapping parameters respectively calibrated from each target wellbore may not meet these standards, resulting in poor and inconsistent calibration and thus propagate the errors all over the prediction results.

In some implementations, a drilling operation may be performed based on the rock elastic properties. Examples of drilling operations include tripping out the drill bit to be replaced, adjusting a drilling parameter, etc. For instance, the elastic rock properties may indicate unfavorable reservoir quality with respect to hydrocarbon recovery. Accordingly, drilling parameters such as weight on bit (WOB), rotations per minute (RPM), tool face orientation, etc. may be adjusted to steer the drill bit to more favorable rock.

### Example Well System

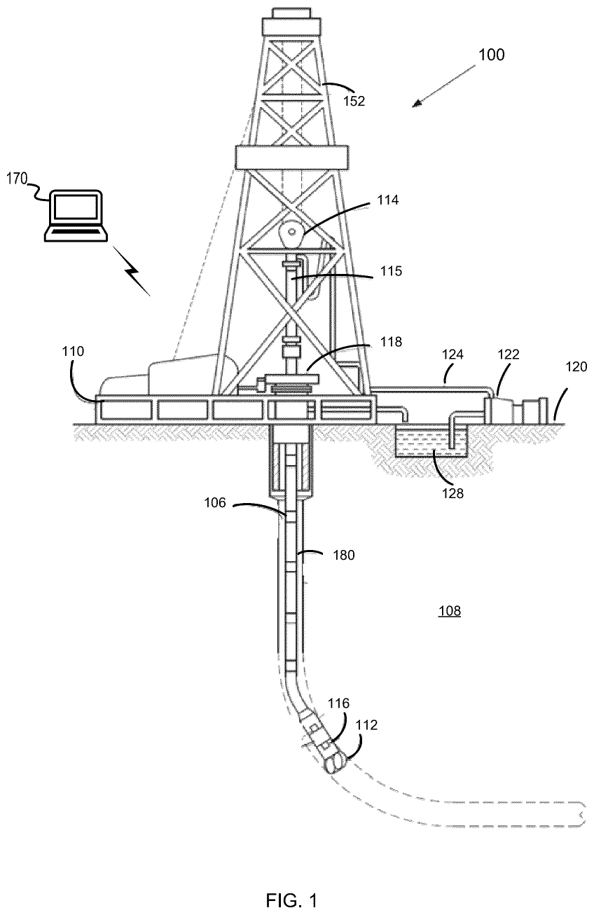

FIG. 1 is a schematic depicting an example well system, according to some implementations. In particular, FIG. 1 is a schematic diagram of a well system 100 that includes a drill string 106 having a drill bit 112 disposed in a wellbore 180 for drilling the wellbore 180 in the subsurface formation 108. While depicted for a land-based well system, example embodiments can be used in subsea operations that employ floating or sea-based platforms and rigs. The drill bit 112 forming the wellbore 180 is an example for which drilling data may be obtained from and utilized by a bit-rock interaction model to determine elastic rock properties of the subsurface formation 108 as described herein can be performed.

The well system 100 may further include a drilling platform 110 that supports a derrick 152 having a traveling block 114 for raising and lowering the drill string 106. The drill string 106 may include, but is not limited to, drill pipe, drill collars, and downhole tools 116. The downhole tools 116 may comprise any of a number of different types of tools including measurement while drilling (MWD) tools, logging while drilling (LWD) tools, mud motors, and others. A kelly 115 may support the drill string 106 as it may be lowered through a rotary table 118. While FIG. 1 is described relative to a drill bit 112, aspects of the disclosure may be applied to any downhole cutting structure or multiple downhole cutting structures. For instance, the drill bit 112 may include roller cone bits, polycrystalline diamond compact (PDC) bits, natural diamond bits, any hole openers, reamers, coring bits, and the like. As the drill bit 112 rotates, it may crush or cut rock to create and extend a wellbore 180 that penetrates various subterranean formations. The drill bit 112 may be rotated by various methods including rotation by a downhole mud motor and/or via rotation of the drill string 106 from the surface 120 by the rotary table 118. A pump 122 may circulate drilling fluid through a feed pipe 124 to the kelly 116, downhole through interior of the drill string 106, through orifices in the drill bit 112, back to the surface 120 via an annulus surrounding the drill string 106, and into a retention pit 128. Parameters of drilling the wellbore 180 may be adjusted to increase, decrease, and/or maintain the rate of penetration (ROP) of the drill bit 112 through the subsurface formation 108. Drilling parameters may include parameters measured at the surface 120 including weight-on-bit (WOB), torque-on-bit (TOB), rotations-per-minute (RPM) of the drill string 106, etc. In some implementations, the downhole tools 116 may include sensors to obtain downhole drilling parameters as the drill bit 112 drills the subsurface formation 108. The drilling parameters obtained from the sensors may include downhole WOB, downhole TOB, downhole RPM, drill bit vibration, etc.

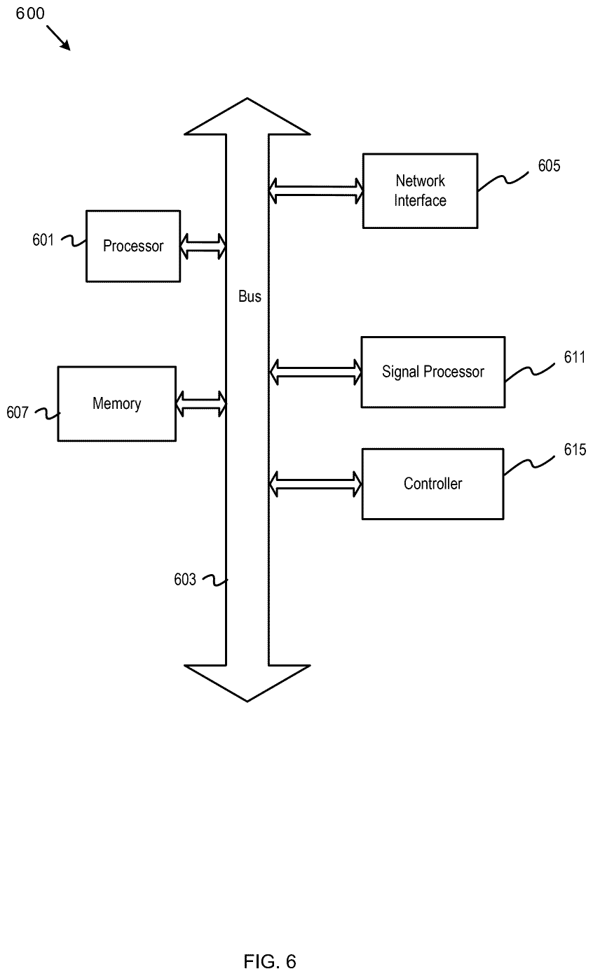

The well system 100 includes a computer 170 that may be communicatively coupled to other parts of the well system 100. The computer 170 can be local or remote to the drilling platform 110. A processor of the computer 170 may perform simulations (as further described below). In some embodiments, the processor of the computer 170 may control drilling operations of the well system 100 or subsequent drilling operations of other wellbores. For instance, the processor of the computer 170 may include a bit-rock interaction model that may determine rock elastic properties based on drilling data obtained while the drill bit 112 drills the wellbore 180 in the subsurface formation 108. The bit-rock interaction model may be calibrated by drilling data and rock elastic properties of a calibration wellbore different from the wellbore 180, resulting in the generation of transferable mapping parameters. When drilling data is obtained and processed, the processor of the computer 170 may input the drilling data and the mapping parameters (from the calibration wellbore) into the bit-rock interaction model to determine the rock elastic properties of the subsurface formation 108. In some implementations, the processor of the computer 170 may perform a drilling operation based on rock elastic properties. An example of the computer 170 is depicted in FIG. 6, which is further described below.

### Example Drill Bit

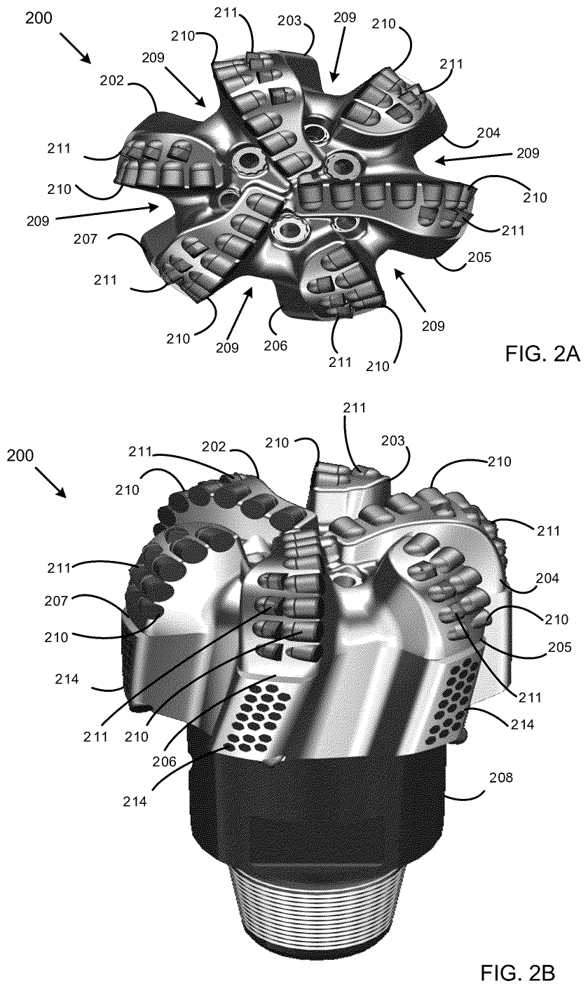

FIGS. 2A-2B are schematics depicting an example drill bit, according to some implementations. In particular, FIGS. 2A-2B depict an example drill bit 200. The drill bit 200 can be an example of the drill bit 112 of FIG. 1. As shown in this example, the drill bit 200 includes six blades 202-207, which can be integrally formed and extend from a bit body 208. The blades 202-207 are separated by flow channels 209 that may include nozzles (i.e., orifices) where drilling mud can be ejected through the drill bit 200 and into the wellbore. Primary cutters 210, backup cutters 211, and depth of cut controllers (DOCCs) may be mounted on the blades 202-207. During drilling, the face of the primary cutters 210 and backup cutters 211 can be in contact with and cut and/or shear the rock of the subsurface formation to create and extend a wellbore. In some instances, the face of the primary cutters 210 may be extended a greater distance from the blades 202-207 than the backup cutters 211 such that only the primary cutters 210 can be in contact with the rock of the subsurface formation. During drilling, the primary cutters 210 may become worn or broken such that one or more of the backup cutters 211 can then be in contact with the rock of the subsurface formation. Many factors including orientation, shape, type, and density of the cutters may vary depending on the design of the drill bit 200. Other drill bit characteristics including the number of blades, the shape of the blades, etc. may vary depending on the subsurface formation environment that the drill bit 200 may drill. Pads 214 may extend from the side of the blades 202-207. The pads 214 may help maintain the size of the wellbore to a full gauge diameter, particularly when cutters become dull and become under gauge.

### Example Bit-Rock Interaction Model

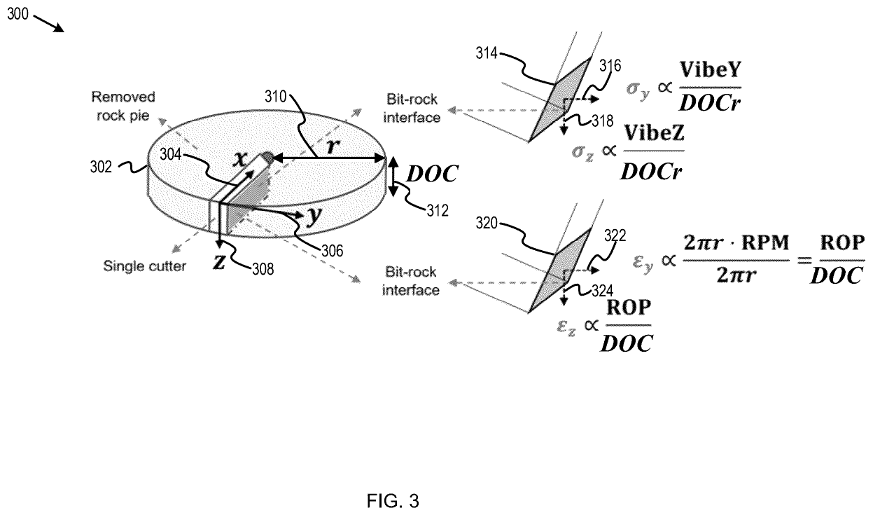

FIG. 3 is an illustration depicting a bit-rock interaction model, according to some implementations. In particular, FIG. 3 depicts a bit-rock interaction model 300 that includes a rock pie 302 being removed by a single cutter, the stress components along tangential and axial directions for the bit-rock interface, and the strain components along tangential and axial directions for the bit-rock interface. The bit-rock interaction model 300 illustrates the relationship between the stress/strain and drilling data along tangential and axial directions. x 304, y 306, and z 308 denote centripetal, tangential, and axial directions of the bit rotation, respectively. r 310 and DOC 312 indicate the bit radius and the depth of cut (DOC), respectively. σ_{y/z} 316/318 and ε_{y/z} 322/324 denote the stress and strain along y/z directions for the bit rock interface 314, 320, respectively. Per definition, stress should be proportional to the forces (y: VibeY, z: VibeZ) divided by the cutting area (DOCr), whereas strain should be proportional to the displacement (y: 2πr·RPM, z: ROP) divided by the base length being compressed (y: 2πr, z: D_{c}).

Representing the proportional relationship by scales and biases, and cancel the common denominator (D_{c}) in both stress and strain, 2D Hooke's law for normal stress and strain may be rearranged as shown in Equation 1 below:

$$[ \begin{matrix}( A \cdot Vibe Y + {A}_{0} ) / r \\ ( B \cdot Vibe Z + {B}_{0} ) / r\end{matrix} ] = [ \begin{matrix}\frac{E}{( 1 - 2 v ) ( 1 + v )} & \frac{Ev}{( 1 - 2 v ) ( 1 + v )} \\ \frac{2 Ev}{( 1 - 2 v ) ( 1 + v )} & \frac{E ( 1 - v )}{( 1 - 2 v ) ( 1 + v )}\end{matrix} ] [ \begin{matrix}C \cdot ROP + {C}_{0} \\ D \cdot ROP + {D}_{0}\end{matrix} ] \qquad ( 1 )$$

Where ρ denotes the rock density. VibeY and VibeZ are the vibration amplitude processed from measurements of strain gauges or accelerometers (or any other suitable sensor proximate the drill bit). ROP represents the rate of penetration. E and ν are the Young's modulus and Poisson's ratio, respectively. A, B, C, D and A₀, B₀, C₀, D₀ are the scales and biases to linearly map the drilling data (VibeY/Z and ROP) into corresponding stress and strain representatives. These mapping parameters, including both scales and biases, may require calibration first before using them to predict the E and v based on Equation 1. Notice the bit radius r, as a constant, can be absorbed into A, A₀ and B, B₀, in which case, the mapping parameters may require recalibration whenever r changes.

In some implementations, the bit-rock interaction model may be extended to anisotropic cases, including different transverse isotropic (TI) cases and/or orthorhombic case, by estimating more independent elastic constants using drilling data of all available directions, including centripetal, tangential, and axial directions. In some implementations, the stress/strain representatives may be extended to estimate rock confined compressive strength (CCS) based on the stress/strain representatives derived from drilling data. Instead of utilizing Hooke's law, we can estimate the CCS by locating the yielding point via fitting the whole stress-strain curve.

### Example Operations

Example operations for determining rock elastic properties utilizing mapping parameters are now described in reference to FIG. 1, FIGS. 2A-2B, and FIG. 3. This section describes operations associated with some implementations of the invention. In the discussion below, the flow diagrams may be described with reference to the example system presented above. In certain implementations, the operations are performed by executing instructions residing on machine-readable media (e.g., software), while in other implementations, the operations are performed by hardware and/or other logic (e.g., firmware). In some implementations, the operations are performed in series, while in other implementations, one or more of the operations can be performed in parallel. Moreover, some implementations perform less than all the operations shown in the flow diagrams.

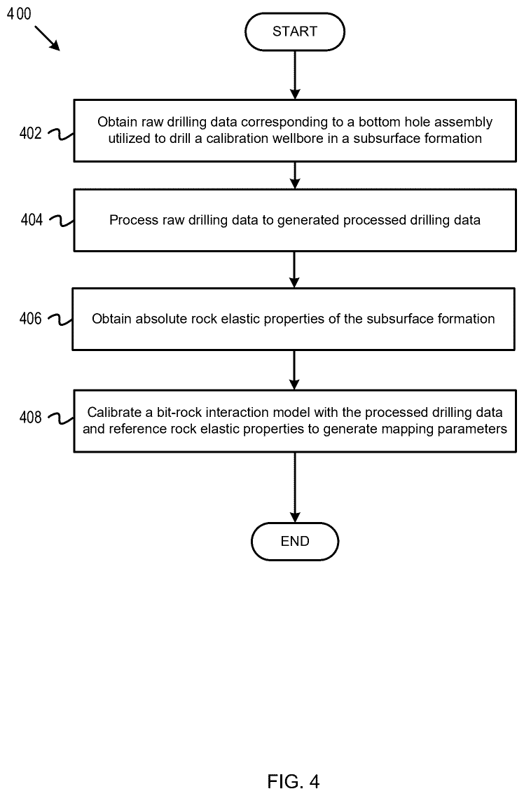

FIG. 4 is a flowchart depicting example operations to calibrate a bit-rock interaction model, according to some implementations. In particular, FIG. 4 includes a flowchart 400 of operations to calibrate a rock-bit interaction model to generate mapping parameters. The rock-bit interaction model is described in reference to the bit-rock interaction model 300 of FIG. 3. Additionally, the operations of the flowchart 400 are described in reference to the processor of the computer 170 of FIG. 1. Operations for the flowchart 400 begin at block 402.

At block 402, the processor of the computer 170 may obtain raw drilling data corresponding to a bottom hole assembly utilized to drill a calibration wellbore in a subsurface formation. The raw drilling data may include drill bit vibrations. In some implementations the drill bit vibrations may be obtained via strain gauges (such as torque on bit (TOB) and/or weight on bit (WOB)) positioned proximate the drill bit. In some implementations the drill bit vibrations may be obtained via accelerometers, gyroscopes, magnetometers, or any other suitable sensor. Moreover, the raw drilling data may include rate of penetration (ROP). The ROP may be the hole depth variation over a period of time. The ROP may be the downhole ROP estimated and/or measured from other apparatus and/or methods. For example, a sensor positioned proximate the drill bit may be configured to obtain downhole ROP measurements while drilling. In some implementations, the ROP may be replaced with RPM. D if reliable RPM and D may be available.

At block 404, the processor of the computer 170 may process the raw drilling data to generate processed drilling data. For example, to process the drill bit vibration measurements, the power spectrum density (PSD) of the drill bit vibration measurements may be determined. The amplitudes of the PSDs may then be averaged for a selected frequency band within a temporal range or a corresponding depth bin to generate processed drill bit vibrations. The frequency band selected may be high enough to avoid influences from the bottom hole assembly (BHA) vibrations, such as the mud motor, and/or the drill string vibrations. In some implementations, the drill bit vibration measurements may be processed in time domain by calculating the windowed average of absolute measurements, or by performing empirical mode decomposition (EMD), etc. To process the ROP, the hole depth variation along time within a temporal range and/or a corresponding depth bin may be averaged. Any suitable process may be used to process the drill bit vibrations and/or the ROP.

At block 406, the processor of the computer 170 may obtain absolute rock elastic properties of the subsurface formation. The absolute rock elastic properties may include Young's modulus, Poisson's ratio, etc. The reference rock elastic properties may be obtained via sonic logs (wireline, LWD, etc.) from the same wellbore being drilled, from casing cement from which the properties are known, background geological models, etc. In some implementations, the absolute rock properties, and corresponding drilling data (obtained in block 402) may include high quality data, including high-resolution and high-fidelity elastic-property references (e.g., sonic logs) and carefully processed drilling data with high sampling rate and proper alignment with the references.

At block 408, the processor of the computer 170 may calibrate a bit-rock interaction model with the processed drilling data and reference rock elastic properties to generate mapping parameters. To calibrate the bit-rock interaction model, the processed drilling data and the absolute elastic rock properties may be input into the bit-rock interaction model to generate mapping parameters for the different drilling data, i.e., the scales (A, B, C, D) and biases (A₀, B₀, C₀, D₀) as shown in Equation 1.

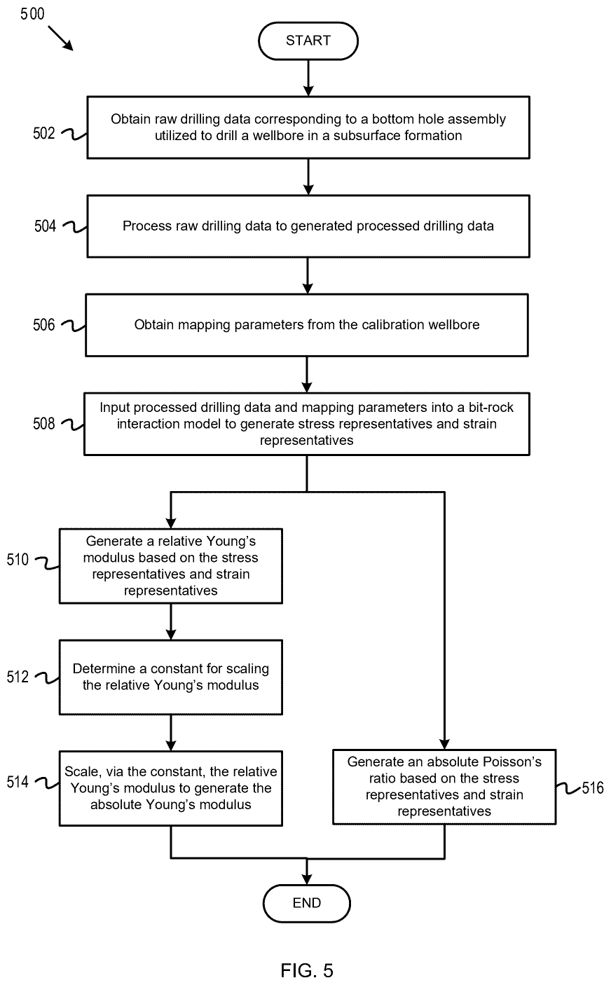

FIG. 5 is a flowchart depicting example operations to determine one or more rock elastic properties of a subsurface formation utilizing transferrable mapping parameters from a calibration wellbore, according to some implementations. In particular, FIG. 5 includes a flowchart 500 of operations to generate stress representatives and strain representatives of a subsurface formation surrounding a wellbore, via a rock-bit interaction model calibrated with mapping parameters, and determine the absolute Young's modulus and absolute Poisson's ratio of the subsurface formation. Moreover, the flowchart 500 includes operations to determine a constant utilized to determine the absolute Young's modulus. The mapping parameters are described in reference to the mapping parameters determined in the flowchart 400 of FIG. 4. The rock-bit interaction model is described in reference to FIG. 3. Additionally, the operations of the flowchart 500 are described in reference to the processor of the computer 170 of FIG. 1.

The operations of the flowchart 500 (i.e., transferring the mapping parameters) may be applied to any n number of wellbores where the effective radius of the BHA differs from that of the BHA used in the calibration wellbore described in FIG. 4. Alternatively, or in addition to, the operations of the flowchart 500 may be applied to any n number of sections of a wellbore where the effective radius of the BHA differs from the BHA used in the calibration wellbore. For example, an intermediate section of a wellbore may be drilled with a BHA, and the drilling parameters and rock elastic properties corresponding to the intermediate section may act as the calibration dataset for the bit-rock interaction model. Accordingly, when another section of the same wellbore (such as the lateral) is drilled with a different BHA than that of the intermediate section, the mapping parameters may be transferred to the new section being drilled to determine the rock elastic properties of said new section of subsurface formation surrounding said new section. Operations for the flowchart 500 begin at block 502.

At block 502, the processor of the computer 170 may obtain raw drilling data corresponding to a bottom hole assembly utilized to drill a wellbore in a subsurface formation. In some implementations, the BHA may be different than the BHA used to drill the calibration wellbore described in FIG. 4. For example, the effective radius of the drill bit on the BHA may be less than or greater than the effective radius of the drill bit on the BHA used to drill the calibration wellbore. Similar to block 402 of FIG. 4, the raw drilling data may include drill bit vibrations, ROP, etc.

At block 504, the processor of the computer 170 may process the raw drilling data to generate processed drilling data. Processing the raw drilling data may be similar to operations described in block 404 of FIG. 4. For example, the power spectrum density (PSD) of the drill bit vibration measurements may be determined. The amplitudes of the PSDs may then be averaged for a selected frequency band within a temporal range or a corresponding depth bin to generate processed drill bit vibrations. The frequency band selected may be high enough to avoid influences from the bottom hole assembly (BHA) vibrations, such as the mud motor, and/or the drill string vibrations. Moreover, to process the ROP, the hole depth variation along time within a temporal range and/or a corresponding depth bin may be averaged.

At block 506, the processor of the computer 170 may obtain mapping parameters. The mapping parameters may be the same mapping parameters from the calibration of the bit-rock interaction model (as described in block 408 of FIG. 4) employed on the calibration wellbore. For example, the mapping parameters may include the scales (A, B, C, D) and biases (A₀, B₀, C₀, D₀) as shown in Equation 1.

At block 508, the processor of the computer 170 may input the processed drilling data and mapping parameters into a bit-rock interaction model to generate stress representatives and strain representatives. The stress/train representatives may be the elements of the vectors on both sides of Equation 1. For example, the stress representative may include the elements of the vector

$$[ \begin{matrix}A \cdot Vibe Y + {A}_{0} \\ B \cdot Vibe Z + {B}_{0}\end{matrix} ]$$

and the strain representatives may include the elements of the vector

$$[ \begin{matrix}C \cdot ROP + {C}_{0} \\ D \cdot ROP + {D}_{0}\end{matrix} ] .$$

At block 510, the processor of the computer 170 may generate a relative Young's modulus based on the stress representatives and strain representatives. The relative Young's modulus may be determined utilizing Equation 1 with the stress representatives and strain representatives determined in block 508 and the mapping parameters transferred from the calibration wellbore described in FIG. 4. Due to the difference of the effective bit radius between the BHA of the calibration wellbore drilled and the BHA of the wellbore being drilled, the Young's modulus generated in Block 510 is one relative to the Young's modulus determined for the calibration wellbore. Thus, a constant must be determined to scale the mapping parameters to obtain the absolute Young's modulus for the wellbore being drilled.

At block 512, the processor of the computer 170 may determine a constant for scaling the relative Young's modulus. According to Equation 1, the calibrated mapping parameters should be transferrable if the absorbed r is known. However, the bit radius here is defined for the effective single cutter simplified from the whole drill bit, so it normally may not equal to the real radius of the drill bit which, in some implementations, may contain multiple blades with dozens of cutters in various cutting structures. In addition to the drill bit, other components of the BHA (such as the mud motor) may also influence the simplified single-cutter bit radius value. Therefore, the mapping parameters must absorb this unique unknown effective bit radius r, which is determined by a unique BHA. Hence, directly applying the mapping parameters from one wellbore to another may result in inaccurate rock property estimation.

Although directly using transferred mapping parameters do not yield absolute rock elastic properties, Equation 1 suggests that they can be used to provide the relative variation of E along with the absolute values of ν (described in Block 516 below), since r only changes across wellbores but remains the same along depth for the same wellbore if the BHA does not change. Assuming the effective bit radius for the wellbore being drilled is rₚ, and for calibration wellbore is r_{c}, the constant scale s between the predicted relative Young's modulus E_{prd} and the reference absolute Young's modulus E_{ref} may be defined by Equation 2 as shown below, according to Equation 1:

$$s = \frac{{E}_{ref}}{{E}_{prd}} = \frac{{r}_{c}}{{r}_{p}} . \qquad ( 2 )$$

Hence, to apply the mapping parameters calibrated from one wellbore drilled by certain BHA to another wellbore drilled by a different BHA, the estimated Young's modulus may be scaled by the constant s.

To estimate the constant s for each prediction wellbore, the effective bit radius from calibration and prediction wellbores may be compared, and/or the reference and predicted Young's modulus from the same depth of the prediction wellbore may be compared, as shown in Equation 2 above.

Comparing the effective bit radius may not require any prior knowledge of the target formation, but it may rely on thorough understanding of how the BHA configuration influences the effective bit radius under the scenario of elastic property estimation. In some implementations, the effective bit radius for specific BHA can also be determined by lab drilling tests. In some implementations there may be no readily available method to pre-determine such effective bit radius purely from the BHA configuration. Determination of the Young's modulus may not need to calculate the effective bit radius theoretically, but additional information about the target formation may be provided. In some implementations, one pair of corresponding reference and predicted E at arbitrary depth along the current wellbore being drilled may be sufficient to calculate the scalar s. However, due to inevitable errors in the raw estimation and in the reference, it may be beneficial to use the average values within a depth range for both the reference and the prediction. The required reference Young's modulus may not need to be in high-resolution or well matched with the drilling data. Rather, it may require an average within a depth range, which can be retrieved from various sources, including the background geological model, sonic logs from neighboring wells, or LWD sonic logging slightly behind the drill bit for real-time at-bit evaluation to facilitate “zero-delay” geosteering. In some implementations, the reference Young's modulus may be obtained via core measurements, surface and VSP seismic data, or any other suitable elastic information coming from the target wellbore or its neighboring area.

At block 514, the processor of the computer 170 may scale, via the constant, the relative Young's modulus to generate the absolute Young's modulus. The constant, s (determined in Equation 2), may be applied to the mapping parameters and, accordingly, the relative Young's modulus may be scaled to generate the absolute Young's modulus for the subsurface formation surrounding the current wellbore being drilled.

At block 516, the processor of the computer 170 may generate an absolute Poisson's ratio based on the stress representatives and strain representatives. In some implementations, the absolute Poisson's ratio may directly be determined, via the stress/strain representatives, without any scaling.

The operations of the flowchart 500 may be applied to any other wellbore with a BHA different than the BHA used to drill the calibration wellbore. Any wellbore may utilize the same transferred mapping parameters determined from the drilling data and rock elastic properties of the calibration wellbore, via the bit-rock interaction model. In some implementations, multiple sets of transferred mapping parameters from different calibration datasets may be utilized to obtain an averaged estimation and the corresponding uncertainty.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 302-308 of flowchart 300 can be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

### Example Computer

FIG. 6 is a block diagram depicting an example computer, according to some implementations. FIG. 6 depicts a computer 600 for determining rock elastic properties of subsurface formations with transferrable mapping parameters. The computer 600 includes a processor 601 (possibly including multiple processors, multiple cores, multiple nodes, and/or implementing multi-threading, etc.). The computer 600 includes memory 607. The memory 607 may be system memory or any one or more of the above already described possible realizations of machine-readable media. The computer 600 also includes a bus 603 and a network interface 605. The computer 600 can communicate via transmissions to and/or from remote devices via the network interface 605 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 600 also includes a processor 611 and a controller 615 which may perform the operations described herein. For example, the processor 611 may calibrate a bit-rock interaction model to generate transferrable mapping parameters with drilling data and rock elastic properties corresponding to a calibration wellbore. The processor 611 may also determine a scaling factor for the mapping parameters, and determine the rock elastic properties of a subsurface formation for a target wellbore. The controller 615 may execute one or more actions based on the rock elastic properties of the subsurface formation. The processor 611 and the controller 615 can be in communication. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

While the aspects of the disclosure are described with reference to various implementations and exploitations, it will be understood that these aspects are illustrative and that the scope of the claims is not limited to them. In general, techniques for determining rock elastic properties described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub combination. Moreover, although features may be described as acting in certain combinations and even initially claimed as such, one or more features from a claimed combination may in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### EXAMPLE IMPLEMENTATIONS

Implementation #1: A method comprising: obtaining a first drilling dataset corresponding to a first bottom hole assembly drilling a first wellbore; determining mapping parameters based on the first drilling dataset and elastic properties of the first wellbore; obtaining a second drilling dataset corresponding to a second bottom hole assembly drilling a second wellbore; and determining the elastic properties of the second wellbore based on the second drilling data and the mapping parameters.

Implementation #2: The method of Implementation #1, wherein the first drilling dataset and the second drilling dataset include any one or more of torque on bit, weight on bit, drill bit accelerations, rotations per minute, depth of cut and rate of penetration for the respective wellbore.

Implementation #3: The method of Implementation #1 or 2, wherein the elastic properties include Young's modulus and Poisson's ratio for the respective wellbore.

Implementation #4: The method of any one or more of Implementation #1-3 further comprising: determining, via a bit-rock interaction model, stress representatives and strain representatives of the second wellbore based on the second drilling dataset and the mapping parameters; and determining the elastic properties of the second wellbore based on the stress representatives and the strain representatives.

Implementation #5: The method of Implementation #4 further comprising; determining an absolute Poisson's ratio based on the stress representatives and the strain representatives.

Implementation #6: The method of Implementation #4 or 5 further comprising; determining a relative Young's modulus based on the stress representatives and the strain representatives; and scaling the relative Young's modulus by a constant to determine an absolute Young's modulus of the second wellbore.

Implementation #7: The method of Implementation #6, wherein the constant is based on a predicted Young's modulus of the second wellbore and a reference Young's modulus.

Implementation #8: The method of Implementation #1-7, wherein the elastic properties of the first wellbore are obtained from sources including background geological models, sonic logs from offset wellbores, logging while drilling sonic logs from the first wellbore, or any combination thereof.

Implementation #9: A system comprising: a first bottom hole assembly configured to drill a first wellbore; a second bottom hole assembly configured to drill a second wellbore; a processor; and a computer-readable medium having instructions stored thereon that are executable by the processor to cause the processor to, obtain a first drilling dataset corresponding to the first bottom hole assembly drilling the first wellbore; determine mapping parameters based on the first drilling dataset and elastic properties of the first wellbore; obtain a second drilling dataset corresponding to the second bottom hole assembly drilling the second wellbore; and determine the elastic properties of the second wellbore based on the second drilling data and the mapping parameters.

Implementation #10: The system of Implementation #9, wherein the first drilling dataset and the second drilling dataset include any one or more of torque on bit, weight on bit, drill bit accelerations, rotations per minute, and rate of penetration for the respective bottom hole assembly.

Implementation #11: The system of Implementation #9 or 10, wherein the elastic properties include Young's modulus and Poisson's ratio for the respective wellbore.

Implementation #12: The system of Implementation #9-11 further comprising: determining, via a bit-rock interaction model, stress representatives and strain representatives of the second wellbore based on the second drilling dataset and the mapping parameters; and determining the elastic properties of the second wellbore based on the stress representatives and the strain representatives.

Implementation #13: The system of Implementation #12 further comprising; determining an absolute Poisson's ratio based on the stress representatives and the strain representatives.

Implementation #14: The system of Implementation #12 or 13 further comprising; determining a relative Young's modulus based on the stress representatives and the strain representatives; and scaling the relative Young's modulus by a constant to determine an absolute Young's modulus of the second wellbore.

Implementation #15: The system of Implementation #14, wherein the constant is based on a predicted Young's modulus of the second wellbore and a reference Young's modulus.

Implementation #16: The system of any one or more of Implementation #9-15, wherein the elastic properties of the first wellbore are obtained from sources including background geological models, sonic logs from offset wellbores, logging while drilling sonic logs from the first wellbore, or any combination thereof.

Implementation #17: A non-transitory, computer-readable medium having instructions stored thereon that are executable by a processor to perform operations comprising: obtaining a first drilling dataset corresponding to a first bottom hole assembly drilling a first wellbore; determining mapping parameters based on the first drilling dataset and elastic properties of the first wellbore; obtaining a second drilling dataset corresponding to a second bottom hole assembly drilling a second wellbore; and determining the elastic properties of the second wellbore based on the second drilling data and the mapping parameters.

Implementation #18: The non-transitory, computer-readable medium of Implementation #17, wherein the first drilling dataset and the second drilling dataset include any one or more of torque on bit, weight on bit, drill bit accelerations, rotations per minute, and rate of penetration for the respective bottom hole assembly.

Implementation #19: The non-transitory, computer-readable medium of Implementation #17 or 18, wherein the elastic properties include Young's modulus and Poisson's ratio for the respective wellbore.

Implementation #20: The non-transitory, computer-readable medium of any one of more of Implementation #17-19 further comprising: determining, via a bit-rock interaction model, stress representatives and strain representatives of the second wellbore based on the second drilling dataset and the mapping parameters; and determining the elastic properties of the second wellbore based on the stress representatives and the strain representatives.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining a first drilling dataset corresponding to a first bottom hole assembly drilling a first wellbore;
determining mapping parameters based on the first drilling dataset and elastic properties of the first wellbore;
obtaining a second drilling dataset corresponding to a second bottom hole assembly drilling a second wellbore; and
determining the elastic properties of the second wellbore based on the second drilling data and the mapping parameters.

2. The method of claim 1, wherein the first drilling dataset and the second drilling dataset include any one or more of torque on bit, weight on bit, drill bit accelerations, rotations per minute, depth of cut and rate of penetration for the respective wellbore.

3. The method of claim 1, wherein the elastic properties include Young's modulus and Poisson's ratio for the respective wellbore.

4. The method of claim 1 further comprising:
determining, via a bit-rock interaction model, stress representatives and strain representatives of the second wellbore based on the second drilling dataset and the mapping parameters; and
determining the elastic properties of the second wellbore based on the stress representatives and the strain representatives.

5. The method of claim 4 further comprising;
determining an absolute Poisson's ratio based on the stress representatives and the strain representatives.

6. The method of claim 4 further comprising;
determining a relative Young's modulus based on the stress representatives and the strain representatives; and
scaling the relative Young's modulus by a constant to determine an absolute Young's modulus of the second wellbore.

7. The method of claim 6, wherein the constant is based on a predicted Young's modulus of the second wellbore and a reference Young's modulus.

8. The method of claim 1, wherein the elastic properties of the first wellbore are obtained from sources including background geological models, sonic logs from offset wellbores, logging while drilling sonic logs from the first wellbore, or any combination thereof.

9. A system comprising:
a first bottom hole assembly configured to drill a first wellbore;
a second bottom hole assembly configured to drill a second wellbore;
a processor; and
a computer-readable medium having instructions stored thereon that are executable by the processor to cause the processor to,
obtain a first drilling dataset corresponding to the first bottom hole assembly drilling the first wellbore;
determine mapping parameters based on the first drilling dataset and elastic properties of the first wellbore;
obtain a second drilling dataset corresponding to the second bottom hole assembly drilling the second wellbore; and
determine the elastic properties of the second wellbore based on the second drilling data and the mapping parameters.

10. The system of claim 9, wherein the first drilling dataset and the second drilling dataset include any one or more of torque on bit, weight on bit, drill bit accelerations, rotations per minute, and rate of penetration for the respective bottom hole assembly.

11. The system of claim 9, wherein the elastic properties include Young's modulus and Poisson's ratio for the respective wellbore.

12. The system of claim 9 further comprising:
determining, via a bit-rock interaction model, stress representatives and strain representatives of the second wellbore based on the second drilling dataset and the mapping parameters; and
determining the elastic properties of the second wellbore based on the stress representatives and the strain representatives.

13. The system of claim 12 further comprising;
determining an absolute Poisson's ratio based on the stress representatives and the strain representatives.

14. The system of claim 12 further comprising;
determining a relative Young's modulus based on the stress representatives and the strain representatives; and
scaling the relative Young's modulus by a constant to determine an absolute Young's modulus of the second wellbore.

15. The system of claim 14, wherein the constant is based on a predicted Young's modulus of the second wellbore and a reference Young's modulus.

16. The system of claim 9, wherein the elastic properties of the first wellbore are obtained from sources including background geological models, sonic logs from offset wellbores, logging while drilling sonic logs from the first wellbore, or any combination thereof.

17. A non-transitory, computer-readable medium having instructions stored thereon that are executable by a processor to perform operations comprising:
obtaining a first drilling dataset corresponding to a first bottom hole assembly drilling a first wellbore;
determining mapping parameters based on the first drilling dataset and elastic properties of the first wellbore;
obtaining a second drilling dataset corresponding to a second bottom hole assembly drilling a second wellbore; and
determining the elastic properties of the second wellbore based on the second drilling data and the mapping parameters.

18. The non-transitory, computer-readable medium of claim 17, wherein the first drilling dataset and the second drilling dataset include any one or more of torque on bit, weight on bit, drill bit accelerations, rotations per minute, and rate of penetration for the respective bottom hole assembly.

19. The non-transitory, computer-readable medium of claim 17, wherein the elastic properties include Young's modulus and Poisson's ratio for the respective wellbore.

20. The non-transitory, computer-readable medium of claim 17 further comprising:
determining, via a bit-rock interaction model, stress representatives and strain representatives of the second wellbore based on the second drilling dataset and the mapping parameters; and
determining the elastic properties of the second wellbore based on the stress representatives and the strain representatives.
